(19) United States
(12) Patent Application Publication
(10) Pub. No.: US 2024/0025143 A1
(43) Pub. Date: Jan. 25, 2024

(54) ADVANCED DIELECTRIC METHODS AND APPLICATIONS

(71) Applicant: Honeywell International Inc., Charlotte, NC (US)

(72) Inventor: Christopher Coy FULLER, Plymouth, MN (US)

(73) Assignee: Honeywell International Inc., Charlotte, NC (US)

(21) Appl. No.: 17/813,989

(22) Filed: Jul. 21, 2022

(51) Int. Cl. B32B 5/16; B32B 5/30

(52) U.S. Cl. CPC B32B 5/16; B32B 5/30; B32B 2264/107; B32B 2264/1056; B32B 2264/20; B32B 2307/202; B32B 2307/204; B32B 2457/00; B32B 2311/30; B32B 2315/02

(57) ABSTRACT

An apparatus to emit and/or receive electromagnetic waves, the apparatus including a first material having a high electrical permittivity, and a second material having a high magnetic permeability, wherein the first material contacts the second material while maintaining a dielectric enhancement between the first material and the second material by combining the first material and the second material under a low pressure.

### TECHNICAL FIELD

Various embodiments of the present disclosure relate generally to a magneto-dielectric composite materials that maintain a dielectric enhancement between materials having high electrical permittivity and materials having high magnetic permeability.

### BACKGROUND

Electro-magnetic waves, such as radio waves, incident on a boundary between two materials, reflect or pass into each material based on the difference in intrinsic impedance between the materials. For boundaries between air and high permittivity materials, a mismatch occurs that results in a loss of efficiency. Therefore, there is a need in the art for materials and devices containing materials that provide relatively high efficiency for electro-magnetic waves at material boundaries. Additionally, there is a need to dramatically shrink the physical size of electromagnetic objects like lenses and antennas while greatly increasing their electrical size.

The present disclosure is directed to overcoming one or more of these above-referenced challenges.

### SUMMARY OF THE DISCLOSURE

In some aspects, the techniques described herein relate to an apparatus to emit and/or receive electromagnetic waves, the apparatus including: a first material having a high electrical permittivity; and a second material having a high magnetic permeability, wherein the first material contacts the second material while maintaining a dielectric enhancement between the first material and the second material by combining the first material and the second material under a low pressure.

In some aspects, the techniques described herein relate to an apparatus, wherein a value of the electrical permittivity is within a factor of 10 of a value of the magnetic permeability.

In some aspects, the techniques described herein relate to an apparatus, wherein the first material forms a composite with the second material.

In some aspects, the techniques described herein relate to an apparatus, wherein the low pressure is less than 1.85 MPa.

In some aspects, the techniques described herein relate to an apparatus, wherein the first material includes a ceramic material provided in one or more of a powder, liquid, or solid form, and the second material includes a ferrite material provided in one or more of a powder, liquid, or solid form.

In some aspects, the techniques described herein relate to an apparatus, wherein a value of the electrical permittivity is in a range from approximately 100 to approximately 500,000, and a value of the magnetic permeability is in a range from approximately 100 to approximately 500,000.

In some aspects, the techniques described herein relate to an apparatus, wherein the apparatus is provided to operate at a frequency below approximately 10 kHz and up to approximately 10 GHz.

In some aspects, the techniques described herein relate to an apparatus, wherein the apparatus is one or more of an antenna, a lens, a composite, or a waveguide.

In some aspects, the techniques described herein relate to an apparatus, wherein the apparatus provides a miniaturization factor above 1000.

In some aspects, the techniques described herein relate to an apparatus, wherein a characteristic impedance of the apparatus is 377 Ohms to match a characteristic impedance of air.

In some aspects, the techniques described herein relate to an apparatus to emit and/or receive electromagnetic waves, the apparatus including: a first material having a high electrical permittivity; and a second material having a high magnetic permeability combined with the first material while maintaining a dielectric enhancement between the first material and the second material by combining the first material and the second material under a low pressure.

In some aspects, the techniques described herein relate to an apparatus, wherein a value of the electrical permittivity is within a factor of 10 of a value of the magnetic permeability.

In some aspects, the techniques described herein relate to an apparatus, wherein the first material forms a composite with the second material.

In some aspects, the techniques described herein relate to an apparatus, wherein the low pressure is less than 1.85 MPa.

In some aspects, the techniques described herein relate to an apparatus, wherein the first material includes a ceramic material provided in one or more of a powder, liquid, or solid form, and the second material includes a ferrite material provided in one or more of a powder, liquid, or solid form.

In some aspects, the techniques described herein relate to an apparatus, wherein a value of the electrical permittivity is in a range from approximately 100 to approximately 500,000, and a value of the magnetic permeability is in a range from approximately 100 to approximately 500,000.

In some aspects, the techniques described herein relate to an apparatus, wherein the apparatus is provided to operate at a frequency below approximately 10 kHz and up to approximately 10 GHz.

In some aspects, the techniques described herein relate to an apparatus, wherein the apparatus is one or more of an antenna, a lens, a composite, or a waveguide.

In some aspects, the techniques described herein relate to an apparatus, wherein the apparatus provides a miniaturization factor above 1000.

In some aspects, the techniques described herein relate to an apparatus, wherein a characteristic impedance of the apparatus is 377 Ohms to match a characteristic impedance of air.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a three dimensional illustration of an apparatus, according to one or more embodiments.

FIG. 2 is a three dimensional illustration of an apparatus, according to one or more embodiments.

FIG. 3 is a three dimensional illustration of an apparatus, according to one or more embodiments.

FIG. 4 is a three dimensional illustration of an apparatus, according to one or more embodiments.

FIG. 5A is a block diagram of a general antenna system, according to one or more embodiments.

FIG. 5B is a front view of a radar system including antennas with a composite material, according to one or more embodiments.

FIG. 5C is a rear view of the radar system of FIG. 5B, according to one or more embodiments.

FIG. 6 is a top view of an antenna array, according to one or more embodiments.

FIG. 7A is a block diagram of a system to tune an apparatus, according to one or more embodiments.

FIG. 7B is a block diagram of a mixer, according to one or more embodiments.

FIG. 7C is a block diagram of a mixer formed in an antenna, according to one or more embodiments.

FIG. 7D is a block diagram of an antenna having both a mixer and a filter formed therein, according to one or more embodiments.

FIG. 8 is a side cross-sectional view of stealth absorber material, according to one or more embodiments.

FIG. 9 is a side view of a radome, according to one or more embodiments.

### DETAILED DESCRIPTION OF EMBODIMENTS

Various embodiments of the present disclosure relate generally to a magneto-dielectric composite material that maintains a dielectric enhancement between a first material having a high electrical permittivity and a second material having a high magnetic permeability and, more particularly, to magneto-dielectric composite materials composed of materials which have high electrical permittivity and high magnetic permeability with relative values within approximately a factor of 10 of each other.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Magneto-dielectrics are composites composed of materials which have high electrical permittivity and high magnetic permeability with relative values within a factor of 10 of each other. In past efforts by others, the maximum relative permittivity combined with maximum relative permeability have been less than a factor of approximately 20. The material properties of each constituent are available with relative material properties in the thousands, but nobody has previously found a way to combine the high permeability and high permittivity materials together without destroying the very high native properties caused by dielectric enhancement. This disclosure provides multiple methods to make composites with very high permittivity matched to very high permeability in one composite without destroying the dielectric enhancement. This disclosure provides embodiments with composite materials measured with miniaturization factors (index of refraction) in the thousands using low-cost materials, although not all described composites are made using low-cost materials. When making composites using finely controlled pressure and temperatures, the materials may be pressed into a shape and processed in ways which do not destroy dielectric enhancement. Dielectric enhancement is a very domain position dependent problem, and so the domains must be in very close proximity, but the boundaries between the domains are not to be destroyed, enabling maximum material properties. Existing individual high permittivity materials may be combined with existing high permeability materials in ways that enable the use of the effective material theory to provide the overall capability to the entire composite of the combination of the constituent materials.

This disclosure may provide a solution long sought by industry and academia to dramatically shrink the physical size of electromagnetic objects, such as waveguides, lenses, and antennas, for example, while greatly increasing their electrical size with low loss. This technology may enable many new products and may greatly improve existing products. For example, radiofrequency antennas for commercial sensors often have efficiency less than 10%, but with this new technology, efficiency may approach 70% or higher. This technology may improve wireless power technology by enabling an efficiency greater than 50% at distances measured in kilometers. This may allow batteries to be dramatically reduced in size, significantly extend the performance of vehicles, reduce the cost of electric cars, and enable new industries, such as tether-less, lightweight powerful robots such as exoskeletons for the elderly, fire-fighters, construction workers, and many other applications.

Because the new technology may enable physically small devices which are thousands of times larger electrically, dramatic new benefits may be realized, including medical images of unprecedented resolution at very low cost, artificial magnetospheres for the protection of nuclear power workers, astronauts and earth facilities during Coronal Mass Ejections, improved electro-magnetic levitation, and a new form of silent lift and propulsion for uncooperative metal devices and any type of cooperative device. The technology may also greatly improve the efficiency of antennas used for communication purposes including enhancing the security of such communications when long-range near-field communications are incorporated. These new capabilities may be available due to the new technology's ability to efficiently extend an electromagnetic near-field to kilometers in low-cost, physically small devices.

Electro-magnetic waves, such as radio waves, incident on a boundary between two materials, reflect or pass into each material based on the difference in intrinsic impedance between the materials. For boundaries between air and high permittivity materials, a mismatch occurs that results in a loss of efficiency. This mismatch results in a reflection of some of the incident energy. One application that may implement high permittivity materials is an antenna system. The use of high permittivity materials in antenna systems provides benefits. In particular, with the use of high permittivity antenna systems, the size of the antenna may be reduced compared to typical antenna systems, which may lead to greater applications and reduced overall sizes.

Embodiments of the present disclosure may use composite materials. The composite materials may each have at least one of select relative permittivity property values and select relative permeability property values. In some embodiments of near-field lens applications, a portion of the lens may be composite materials and other portions may be non-composite materials, depending upon the characteristics of the source and the system requirements.

Some composite materials may be made to have high permittivity. Moreover, some embodiments may provide composite materials with effective intrinsic impedance that closely matches that of air. The effective intrinsic impedance that closely matches air may be achieved in embodiments by making the relative permeability and permittivity properties of the material relatively close in value (i.e. high-index, where high-index refers to a high value of an index of refraction). By matching the material to the intrinsic impedance of air, with an appropriate geometry, wave reflections may be minimized at the material boundary with the air, which may allow more energy to enter the material than would otherwise occur. Benefits of composite material may be seen in embodiments as described below. Such embodiments may include antennas, lenses, composites, and waveguides, such as antennas having applications for, but not limited to, miniature phased and retrodirective arrays for fuzing applications, smaller antennas for medical implants, ground/building/vehicle/underwater radars, wireless power, MRI antennas, cell phones, two-way radios, trunked radio systems, undersea radar and communications, two-way trunking, commercial broadcast, radio frequency identification (RFID) systems, microscopy, smaller broadband PCBs, cables, more effective anechoic chambers, missile defense systems, etc. Other example embodiments may include stealth coatings to prevent detection by radar, spatial filters (e.g. EMI filters and front-end protection) and mixers as discussed below. Throughout the disclosure, references to an antenna also apply to a lens, a waveguide, and/or a composite to emit and/or receive electromagnetic waves.

The magneto-dielectric composite material may provide miniaturization factors above 100, and above 1000, such as a miniaturization factor of 2300, for example. The composite material may be an array of first materials and second materials, or may be a homogenous medium to support an effective media theory. In the array, the size of each array element may be less than 10% of a wavelength used for the magneto-dielectric composite material. The composite materials may include a Manganese Zinc (MnZn) ferrite material, such as the type used in power transformers, with a permeability of 2300 and a ceramic material, such as the type used in capacitors, with a permittivity of 2200. The ceramic material may include, but is not limited to, barium titanate, for example. The highest possible permeabilities may be provided below 10 kHz and up to 10 GHz, with natural relative permeabilities from 100 to 500,000at low frequencies and natural relative perm ittivities from 100 to 500,000 at wide frequencies. Natural magneto-dielectric properties may range to 100,000, and resonances such as metamaterial effects may increase the effective material properties to approximately 500,000 and may also include negative effective permittivity and permeabilities. The use of resonant methods may increase the effective material properties, or make the effective material properties negative at low loss, up to a factor of approximately five as compared to the natural material properties. Additionally, materials which have both a high permeability and a high permittivity may be used. For example, the composite material may include a first material with a high electrical permittivity and a second material with both a high magnetic permeability and a high electrical permittivity.

Such materials may be used for a di-pole antenna with a miniaturization factor of 176, or a patch antenna with a miniaturization factor of 522, for example. The magneto-dielectric composite material may be used in physically small and electrically large antennas, where the near-field may be extended to hundreds or thousands of meters. The magneto-dielectric composite material may be used in antennas that are 500,000 times smaller than conventional antennas, and may have a fundamental resonance below 10 kHz with a largest dimension below 250 mm and with a power transmission of more than 1000 W.

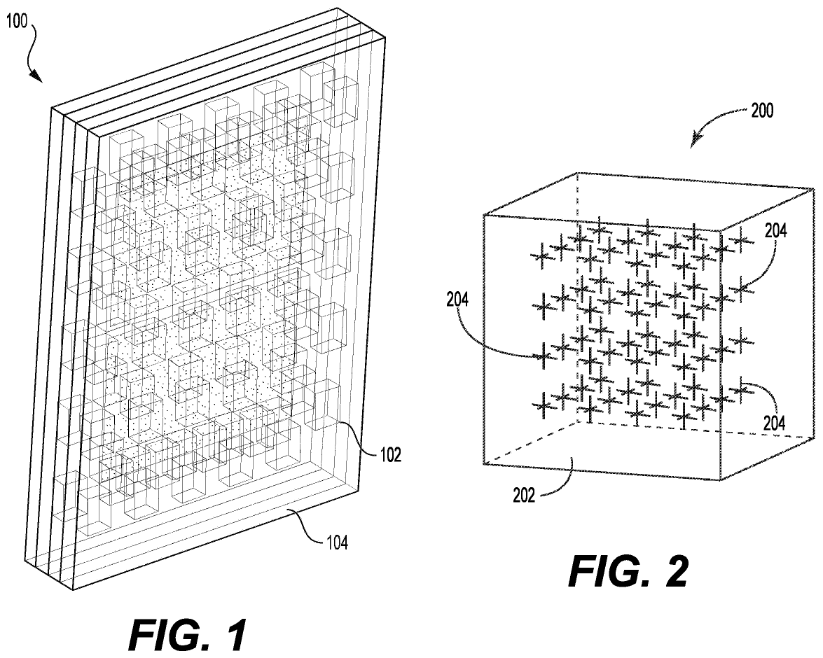

Examples of composite materials 100, 200, and 300 are illustrated in FIGS. 1, 2, 3, and 4 respectively. Referring to FIG. 1, an apparatus including composite material 100 is illustrated. The composite material 100 may include material 102 that has a select relative permittivity property value and material 104 that has a select relative permeability property value. Examples of high permittivity materials used for the material 102 may include, but are not limited to, D100 with a permittivity property value of about 100, or X7R with permittivity property value above 1000. Examples of relatively high permeability materials used for material 104 may include, but are not limited to, Z-phase hexaferrites having permeability property value of 12, G4256 with a permeability property value of about 100, or ferrite or other materials with permeability property value above 1000. In some embodiments, a material with a natural relative high permittivity property value of 2000 or greater is used and material with a natural relatively high permeability property value of 2000 or greater may be used. A variety of manufacturing techniques may be used to manufacture the composite materials.

For example, manufacturing techniques may include (1) combining the materials under low pressure to make 3D filament for 3D printing high index composites; (2) combining liquid, powder or solid forms of the materials in a mold to make any shape, including in a continuous shape, for example, a continuous coating for wires, or metal ribbons; (3) lithography methods to print/etch including photolithography, flexography, block printing at pressures which do not destroy the dielectric enhancement effect; (4) non-contact methods including ink-jet printing, and all forms of sputtering including electronic, potential, etching, and chemical; (5) thin and thick-film methods for forming substrates and printing composites including spin coating, no/low-pressure molds for forming substrates and printing without destroying the dielectric enhancement effect; (6) CNC Machining high permeability ferrite to create holes for adding high permittivity parts; (7) acoustically CNC cutting high permittivity parts to create holes for adding high permeability parts; (8) combining individual high permittivity parts with high permeability parts in an array without cutting individual parts (pre-made by manufacturer to required sizes for the array); (9) nano-composite methods for combining materials which may or may not include a method for electrically isolating microscopic domains such as rust, thin film coatings and other methods to make nano-meter/micron thickness electrical isolations between inclusions, including the use of ceramic precursors for single element oxides, composite oxides, organic content, Hydro EOP; and/or (10) MEMS and MEMS-related manufacturing methods to combine unique high permittivity and high permeability materials possibly along with other materials, for example metal including LiGA (Lithographie, Galvanik and Abformung=lithography, electroplating and molding), Electrochemical Etching, Laser beam etching, and Electrodischarge machining, or any combination thereof.

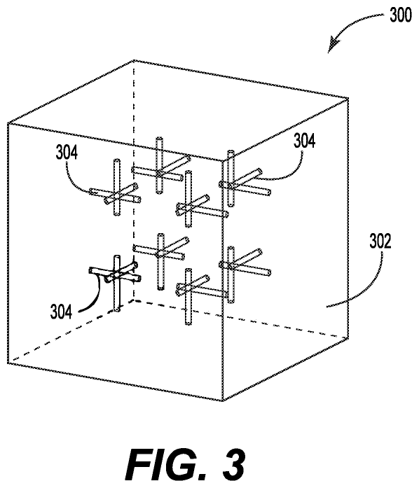

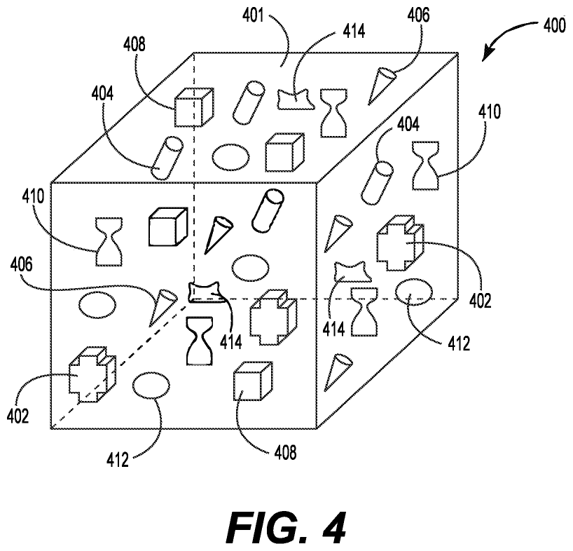

In FIG. 2, an apparatus including composite material 200 is illustrated. Composite material 200 includes material 202 and material 204. In an embodiment, the material 202 has a select relative permittivity property value and the material 204 has a select relative permeability property value. The shapes of the materials 204 may be generally cross shaped. Likewise, in FIG. 3, an apparatus including composite material 300 is illustrated. Composite material 300 includes material 302 that has a select relative permittivity property value and material 304 that has a select relative permeability property value. The materials 304 of FIG. 3 may also generally in a cross shape that is formed with cylinders. The individual composite materials used in embodiments may be any shape, including, but not limited to, a cross 402, sphere 412, cylinder 404, cylinder forms 304, cone 406, hourglass 410, cube 408, arbitrary 414, or combinations thereof, or other shapes, for example, a brick shape, and may include a pattern of inclusions of any shape, including, but not limited to the shapes listed above. For example, FIG. 4 illustrates some possible shapes of materials 402, 404, 406, 408, 410, 412, and 414 in material 401 of composite material 400. It will be understood that different patterns of shapes may be arranged to achieve a structure with desired characteristics. Moreover, the shapes of the materials controls, in part, by losses by surface effects and element to element effects. Hence, changing the shapes of the materials may also be used to achieve a structure with desired characteristics in embodiments.

As illustrated in FIGS. 1, 2, and 3, the materials 104, 204, and 304 may be orientated in three dimensions. For example, referring to FIG. 3, an X axis, a Y axis, and a Z axis are illustrated, and how the materials 304 are orientated in relation to the X, Y and Z axes. Having the materials orientated along the three dimensional axes controls anisotropy and dielectric enhancement. Further, in some embodiments, the materials 304 are located next to each other in the material 302 so that they enhance at least one of the permeability or permittivity of the composite material 300 as discussed above.

Although the composite material 100, 200, 300, and 400 is illustrated in FIGS. 1, 2, 3, and 4 as having generally a cube shape, this is only for illustrative purposes. The composite material may have any shape needed for some applications (e.g. in a z-phase hexaferrites embodiment) including a flat single-layer substrate.

As stated above, composite materials have many applications. One application may involve the use of the composite material in antennas. Examples of antennas include, but are not limited to, microstrip/planar, frequency independent, wire, horn, patch, dish, loop, slot, helical, etc. An antenna is typically one of the largest elements of a radio because the antenna must be on the order of the size of the wavelength for good overall efficiency. By embedding an antenna in a composite of very high permeability and very high permittivity material, it may be possible to dramatically reduce the size of an antenna while preserving antenna efficiency. This may open new applications for antennas, including embodiments of miniature phased and retrodirective arrays for fuzing applications, smaller antennas for medical implants, ground/building/car radars, MRI antennas, cell phones, two-way radios, trunked radio systems, anechoic chambers, missile defense systems, etc. as discussed above. With the use of composite material, the cost and size of the antennas may shrink dramatically. This may result in many new types of products being brought to the market that previously could not be brought to market because of their cost or size.

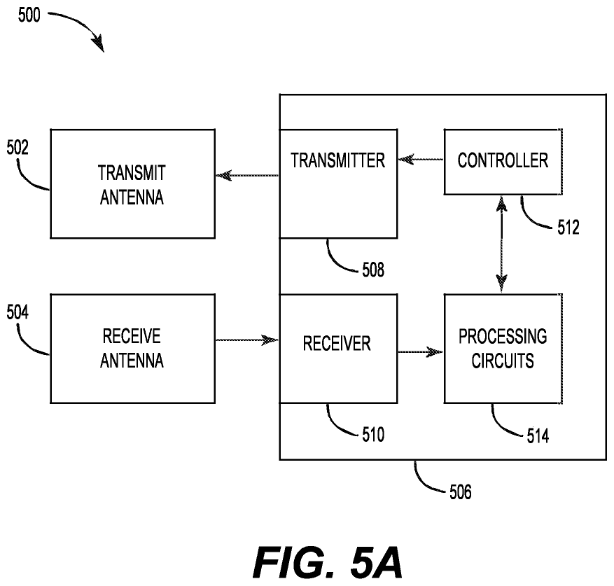

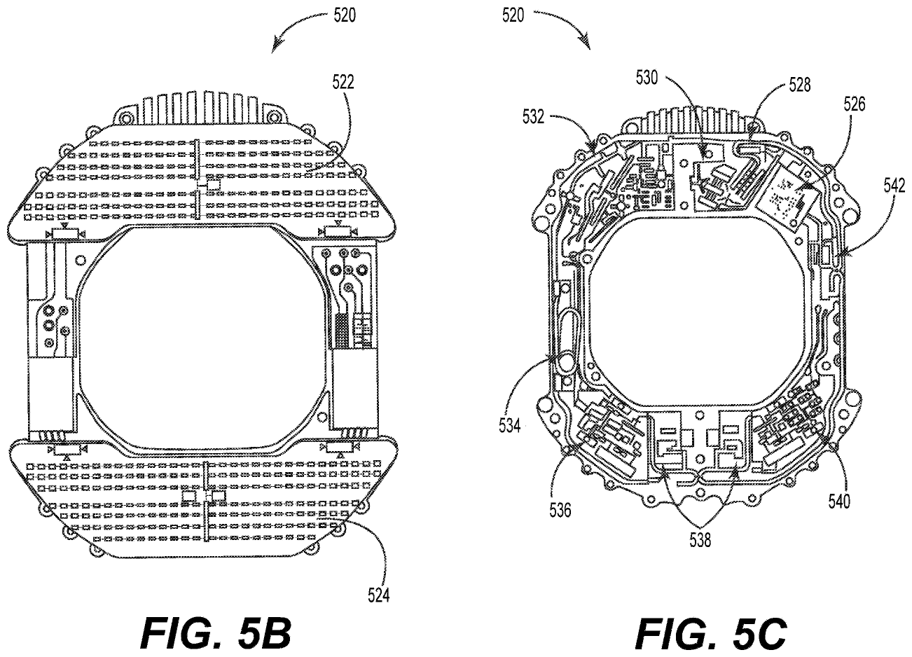

In an antenna embodiment, the relative permeability and permittivity properties in the composite material of the antenna may be selected to be close in value, which causes the effective intrinsic impedance of the material to closely match that of air. By matching the material to the intrinsic impedance of air, and an appropriate geometry, little wave reflection occurs at the material boundary with air, which allows more energy into the antenna, thereby increasing efficiency. An example of a device 500 of embodiments implementing antennas as described above is illustrated in the block diagram of FIG. 5A. As illustrated, this device 500 embodiment includes a transmit antenna 502 and receive antenna 504. At least the receive antenna 504 is made from composite material as discussed above having relative permeability and permittivity properties that are selected relatively close in value which causes the effective intrinsic impedance of the material to closely match that of air. In an embodiment, both the receive and transmit antennas 504 and 502 may be made from composite material as discussed above having relative permeability and permittivity properties that are selected relatively close in value which causes the effective intrinsic impedance of the material to relatively closely match that of air. The device 500 may further include operating circuit 506. Operating circuit 506 may include a receiver 510 coupled to receive signals from the receive antenna 504 and transmitter 508 coupled to transmit signals to the transmit antenna 502. Also included in the operating circuit 506 is a controller 512 and processing circuits 514. The controller controls operation of the device 500. The processing circuit 514 may process signals received by the receiver 510. The device 500 of FIG. 5A could be any device, including, but not limited to, a radar device, a wireless power device, an electro-magnetic levitation or propulsion device, a medical implant device, or an MRI device, as well as communication devices, including but not limited to, cell phones, two-way radios, trunked radios, RFID tag, undersea communication system, anechoic chamber, missile defense system, commercial broadcast system, microscopy system, smaller broadband PCBs, etc.

Referring to FIGS. 5B and 5C, an example of a radar module 520 including two antennas 522 and 524 made of composite material is illustrated. In particular, FIGS. 5B and 5C illustrates front and back views, respectively, of an integrated transmit/receive radar module 520 of an embodiment. The radar module 520 includes the transmit antenna 522 and the receive antenna 524. As stated above, the antennas 522 and 524 are made from a composite material that may include material having a select relative permittivity property value and magnetic material having a select relative permeability property value. The select relative permeability and permittivity properties values may be selected so that the effective intrinsic impedance of the materials match the intrinsic impedance of air. The back view of the radar module 520 of FIG. 5C illustrates that the radar module 520 may include a low phase noise oscillator 526, an up converter 528, a high power transmitter 530, a VCO/Frequency divider 532, a time delay 534, a second down converter 536, LNA receivers 538, another second down converter 540, and frequency multipliers 542.

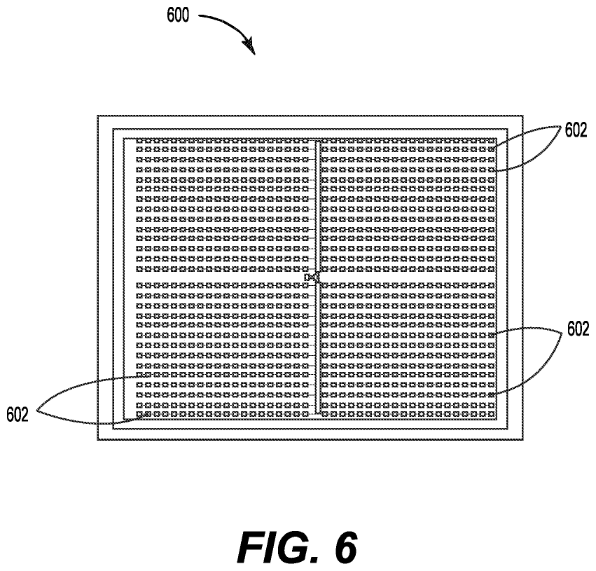

As further discussed above, the composite material may be used in all types of antenna and antenna arrays. For example, referring to FIG. 6, an example of an antenna array 600 is illustrated having a plurality of resonators 602 made from the composite material as discussed above. Resonators 602 of FIG. 6 are individual patch antennas. In an embodiment, the composite material may act as a lens that is positioned over or surrounds the antenna elements to direct energy to the elements. In an embodiment, the resonators 602 may be near field resonators that are used to focus antenna beams while achieving wide bandwidths, wherein the permittivity equals the permeability. In an embodiment, a magneto-dielectric may be used to focus an antenna.

In an embodiment of an antenna array 600, the composite material surrounds antenna elements and acts as parasitic and/or substrate elements. Antenna parasitic material elements are sometimes used in the design of directional antennas to focus antenna energy. However, traditional parasitic elements are also required to be on the order of the size of the radio wavelength to work effectively. Because of the size restriction of antennas and antenna parasitic elements, it may be difficult to develop a directional antenna for miniature proximity sensors, long-range wireless power, electromagnetic propulsion, and other general products which incorporate an antenna, lens, and/or waveguide. Embodiments of composite material that act as parasitic elements are acted upon by electromagnetic waves similar to antennas and traditional parasitic, but may be much smaller because they resonate due to a built-in LC-like resonant structure, as opposed to resonating due to the spatial dimensions of the device used by antennas and traditional parasitics. The LC-like parasitic elements may be much smaller than traditional distributed-type parasitic resonators. Because the elements are very small, many of them may be used per wavelength or antenna to finely control and optimize antenna performance parameters such as beam width. By designing the parasitic elements using a composite of relatively matched high permeability and high permittivity material, it may be possible to dramatically reduce antenna size while preserving antenna efficiency, because the size of the wave is physically small in the high index material, but the material is matched to free-space. The performance of antennas that utilize high index parasitics and possibly substrates may be on-par with, and often better than, high-end electrically large antennas, lenses and/or waveguides, at a cost on-par with presently available low-cost antennas.

In some applications using lenses, it may be necessary to adjust the properties of lens elements dynamically without saturation as the near field changes with time. All antennas generate near-fields that are very complicated and change dramatically with time. For some near-field lens applications, it may not be possible to achieve the desired focal point or other features with lens elements exhibiting constant effective dielectric properties. This is particularly true as the environment of a lens changes and as the near-field penetrates various materials within the environment. Changing the effective material properties to compensate for changes in the near-field of the source antenna may be similar to using antenna array techniques in that different elements of the array are stimulated differently, but in the case of antenna arrays, the source elements may be stimulated differently, for example, in non-linear time invariant stimulation where each cycle of the radiofrequency wave may be different, not the individual lens elements. Antenna array theory also is mostly concerned with the far-field, whereas near-field lens tuning is concerned with adapting the lens elements to compensate for local changes in the near-field.

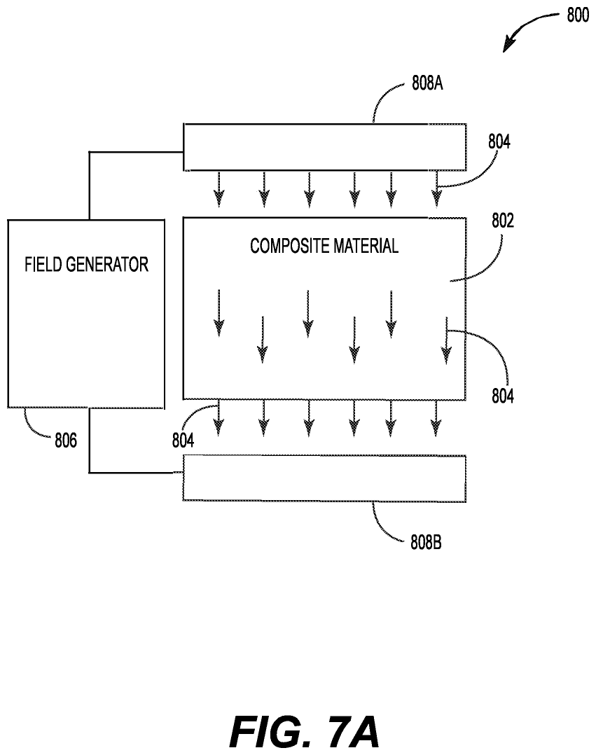

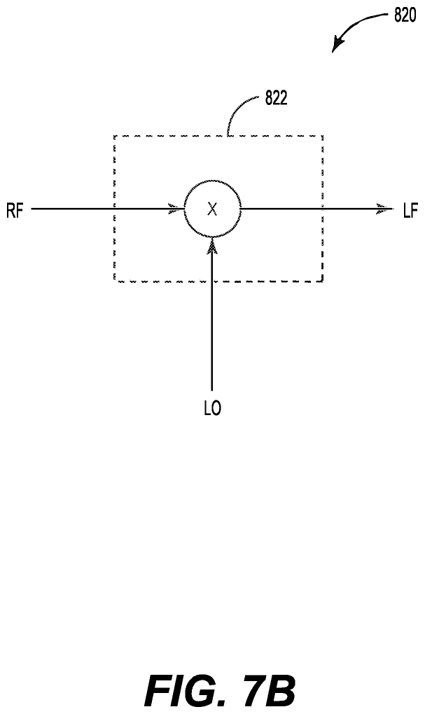

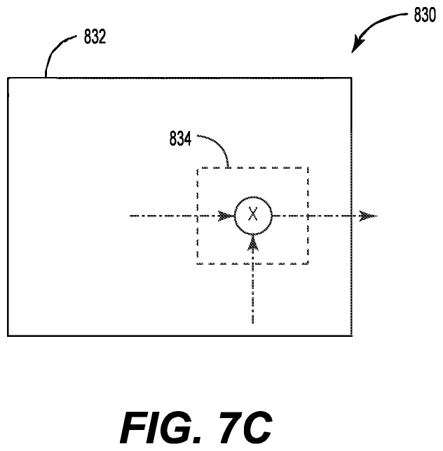

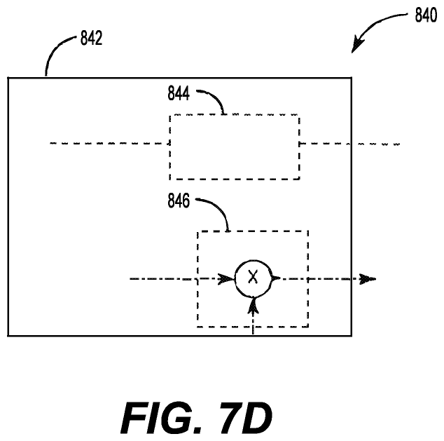

In an embodiment, voltage, current, or externally applied electric or magnetic fields may be used on the composite material to tune the composite material for a desired application. In one or more embodiments, the external electrical or magnetic fields applied to the composite materials may be varied or turned on and off. FIG. 7A illustrates an example of a device 800 with such a system. In FIG. 7A, an apparatus including composite material 802 may be subject to a field such as a magnetic field 804 from one side or generated between plates 808A and 808B by field generator or permanent magnet(s) 806. A mixer may implement the composite material that may be tuned. By turning a magnetic field on and off, the composite material may be used as a mixer. Mixing occurs by alternatively magnetically saturating or detuning (i.e.-turning off) and removing the saturation/tuning in (i.e. turning on). Using magnetic saturation limits the range of frequencies at which the technique may be applied, but a non-magnetic composite material tuning mixer may allow a broad range of frequencies to 10 GHz and higher. Composite materials are effectively nonlinear circuits that use resonance to control effective material properties. By changing local oscillator frequency or amplitude, a mixer may be designed to implement a mixer by changing the non-linear characteristics of a composite material so the composite material behaves like a diode-based mixer. An example mixer 820 is illustrated in FIG. 7B. In this example, a radio frequency (RF) may be combined with a Local Oscillator frequency (LO) to produce an intermediate frequency (LF). Hence, a desired output (such as the LF of FIG. 7B) may be achieved by adjusting one of the frequencies of the inputs (RF or LO). In an embodiment, a magnetic field strength applied to the mixer 820 is selectively varied to change the physical permeability of composite material 822. This changes the resonant frequency, which in turn changes the effective permeability and effective permittivity of the mixer. In an embodiment using the composite material 832 for an antenna 830, a mixer 834 is formed in the antenna 830 itself with the benefits as discussed above. This embodiment is illustrated in FIG. 7C. Combining the mixer with the antenna may provide an opportunity for improved noise performance.

In a similar manner, front-end adaptive filters may be designed to be tuned using the composite material. By tapering the material properties and/or including loss into the composite either intentionally or inherently, the composite may be used for electromagnetic interference (EMI) protection or stealth material and to match to another material. Protecting from EMI using a composite region may be more effective than a protection diode, because a much larger protection region compared to a diode junction is provided using a composite, which allows protection to higher power levels. In an embodiment, at least one filter 844 may be formed in the antenna 840. In FIG. 7D, at least one filter 844 and at least one mixer 846 are formed in an antenna of the composite material 842. By implementing filters and mixing into the antenna substrate, noise performance may be improved by moving filtering and down-conversion as close as possible to the antenna, or tuning to direct around or away from a receiver. High index composites may act as dielectric antennas whether an antenna is embedded in the material or not. The thickness of the material may be such that it is on the order of at least one wavelength (in the composite) in order to shrink the size of antennas dramatically while maintaining efficiency and minimizing reflections at the antenna surface.

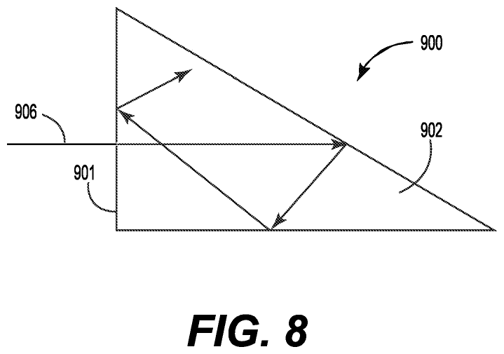

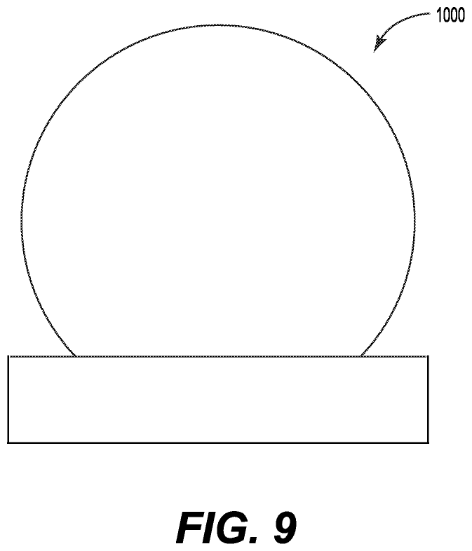

In FIG. 8, stealth absorber material 900 (RF absorber) is formed from the composite material. In this example, composite material 902 is located at an air/material boundary 901. The composite material 902 includes materials having a select relative permeability value and a select relative permittivity value. The select relative permittivity property values and select permeability properties values of the materials may be selected so that the effective intrinsic impedance of the composite material matches the intrinsic impedance of air when designed with an appropriate geometry. Hence, a radar signal 906 reflections are minimized at the air/material boundary 901 but is absorbed into the composite material 902 as illustrated. A natural or effective anisotropic composite material may be used. With the anisotropic material, the absorption or reflection behaves differently depending upon which axis the radio wave is incident. For example, in FIG. 8, the radio wave 906 is first incident on the air/material boundary 901 at generally a perpendicular angle. Because of this angle, the radio wave is received in the composite material 902. As further illustrated, the radio wave is retained in the material 902 when the angle of incidence is not generally perpendicular to a material boundary. The composite materials or resonant near-field composites may be selected that have a permeability that approaches 500,000 and a permeability that also approaches 500,000. In this embodiment, the wave speed is slowed so it effectively eliminates the incident wave from consideration by a radar receiver or makes a vehicle coated with such materials appear to be much further away compared to its actual distance. Examples of items that could implement the stealth absorbing material as a coating include, but are not limited to, missiles, aircraft, boats, anechoic chambers, etc. The stealth material 900 may also be used in EMI protection for electronic circuits and the like.

FIG. 9 illustrates a side view of a radome 1000. Radomes may have a multitude of different shapes. The function of a radome 1000 may be to protect a lens or radar from outside weather environments. The composite material may be used as a radome. The composite material may function as a traditional radome to protect a lens, radar, or other equipment from environmental conditions, as well as function as described above (i.e., including, but not limited to, near-field parasitics, lenses, stealth material, antennas, mixers, filters, etc.).

As shown above, in some aspects, an apparatus including composite material 100 may emit and/or receive electromagnetic waves, and may include a first material 102 having a high electrical permittivity and a second material 104 having a high magnetic permeability. The first material 102 may contact the second material 104 while maintaining a dielectric enhancement between the first material 102 and the second material 104 by combining the first material 102 and the second material 104 under a low pressure. In apparatus including composite material 100, a value of the electrical permittivity may be within a factor of 10 of a value of the magnetic permeability. The first material 102 may form a composite with the second material 104. The low pressure may be less than 1.85 MPa. The first material 102 may include a ceramic material provided in one or more of a powder, liquid, or solid form, and the second material 104 may include a ferrite material provided in one or more of a powder, liquid, or solid form. A value of the electrical permittivity may be in a range from approximately 100 to approximately 500,000, and a value of the magnetic permeability may be in a range from approximately 100 to approximately 500,000. The apparatus including composite material 100 may be provided to operate at a frequency below approximately 10 kHz and up to approximately 10 GHz. The apparatus including composite material 100 may be one or more of an antenna, a lens, a composite, or a waveguide. The apparatus including composite material 100 may provide a miniaturization factor above 1000. A characteristic impedance of the apparatus may be 377 Ohms to match a characteristic impedance of air.

As shown above, in some aspects, an apparatus including composite material 200 may emit and/or receive electromagnetic waves, and may include a first material 202 having a high electrical permittivity and a second material 204 having a high magnetic permeability combined with the first material 202 while maintaining a dielectric enhancement between the first material 202 and the second material 204 by combining the first material 202 and the second material 204 under a low pressure. In apparatus including composite material 200, a value of the electrical permittivity may be within a factor of 10 of a value of the magnetic permeability. The first material 202 may form a composite with the second material 204. The low pressure may be less than 1.85 MPa. The first material 202 may include a ceramic material provided in one or more of a powder, liquid, or solid form, and the second material 204 may include a ferrite material provided in one or more of a powder, liquid, or solid form. A value of the electrical permittivity may be in a range from approximately 100 to approximately 500,000, and a value of the magnetic permeability may be in a range from approximately 2,200 to approximately 500,000. The apparatus including composite material 200 may be provided to operate at a frequency below approximately 10 kHz and up to approximately 10 GHz. The apparatus including composite material 200 may be one or more of an antenna, a lens, a composite, or a waveguide. The apparatus including composite material 200 may provide a miniaturization factor above 1000. A characteristic impedance of the apparatus including composite material 200 may be 377 Ohms to match a characteristic impedance of air.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. An apparatus to emit and/or receive electromagnetic waves, the apparatus comprising:
a first material having a high electrical permittivity; and
a second material having a high magnetic permeability,
wherein the first material contacts the second material while maintaining a dielectric enhancement between the first material and the second material by combining the first material and the second material under a low pressure.

2. The apparatus of claim 1, wherein a value of the electrical permittivity is within a factor of 10 of a value of the magnetic permeability.

3. The apparatus of claim 1, wherein the first material forms a composite with the second material.

4. The apparatus of claim 1, wherein the low pressure is less than 1.85 MPa.

5. The apparatus of claim 1, wherein the first material includes a ceramic material provided in one or more of a powder, liquid, or solid form, and the second material includes a ferrite material provided in one or more of a powder, liquid, or solid form.

6. The apparatus of claim 1, wherein
a value of the electrical permittivity is in a range from approximately 100 to approximately 500,000, and
a value of the magnetic permeability is in a range from approximately 100 to approximately 500,000.

7. The apparatus of claim 1, wherein the apparatus is provided to operate at a frequency below approximately 10 kHz and up to approximately 10 GHz.

8. The apparatus of claim 1, wherein the apparatus is one or more of an antenna, a lens, a composite, or a waveguide.

9. The apparatus of claim 1, wherein the apparatus provides a miniaturization factor above 1000.

10. The apparatus of claim 1, wherein a characteristic impedance of the apparatus is 377 Ohms to match a characteristic impedance of air.

11. An apparatus to emit and/or receive electromagnetic waves, the apparatus comprising:
a first material having a high electrical permittivity; and
a second material having a high magnetic permeability combined with the first material while maintaining a dielectric enhancement between the first material and the second material by combining the first material and the second material under a low pressure.

12. The apparatus of claim 11, wherein a value of the electrical permittivity is within a factor of 10 of a value of the magnetic permeability.

13. The apparatus of claim 11, wherein the first material forms a composite with the second material.

14. The apparatus of claim 11, wherein the low pressure is less than 1.85 MPa.

15. The apparatus of claim 11, wherein the first material includes a ceramic material provided in one or more of a powder, liquid, or solid form, and the second material includes a ferrite material provided in one or more of a powder, liquid, or solid form.

16. The apparatus of claim 11, wherein
a value of the electrical permittivity is in a range from approximately 100 to approximately 500,000, and
a value of the magnetic permeability is in a range from approximately 100 to approximately 500,000.

17. The apparatus of claim 11, wherein the apparatus is provided to operate at a frequency below approximately 10 kHz and up to approximately 10 GHz.

18. The apparatus of claim 11, wherein the apparatus is one or more of an antenna, a lens, a composite, or a waveguide.

19. The apparatus of claim 11, wherein the apparatus provides a miniaturization factor above 1000.

20. The apparatus of claim 11, wherein a characteristic impedance of the apparatus is 377 Ohms to match a characteristic impedance of air.
